(19) United States
(12) Patent Application Publication
(10) Pub. No.: US 2025/0256781 A1
(43) Pub. Date: Aug. 14, 2025

(54) REAR SIDE STRUCTURE OF CARGO BOX OF VEHICLE

(71) Applicants: Hyundai Motor Company, Seoul (KR); Kia Corporation, Seoul (KR)

(72) Inventor: Jun-Young PARK, Hwaseong-si (KR)

(21) Appl. No.: 18/823,146

(22) Filed: Sep. 3, 2024

(30) Foreign Application Priority Data
Feb. 13, 2024 (KR) 10-2024-0020494

(51) Int. Cl. B62D 33/02

(52) U.S. Cl. CPC B62D 33/02

(57) ABSTRACT

A rear side structure of a cargo box of a vehicle includes a side external panel provided on an external side of a cargo box to form an exterior of the cargo box provided at a rear side of a cabin in a vehicle, a side internal panel provided inside the side external panel in the cargo box, a D-post external member forming an external side of a pair of D-post configured to support a tailgate at opposite sides of the cargo box, a D-post internal member forming an internal side of the pair of the D-posts and fastened to the D-post external member, and a rear floor member disposed at a rear end portion of the cargo box in a width direction of the vehicle and connecting to a lower end portion of the pair of the D-posts.

### CROSS-REFERENCE(S) TO RELATED APPLICATIONS

The present application claims priority to Korean Patent Application No. 10-2024-0020494, filed on Feb. 13, 2024, the entire contents of which is incorporated herein for all purposes by this reference.

### BACKGROUND OF THE PRESENT DISCLOSURE

### Field of the Present Disclosure

The present disclosure relates to a rear side structure of a cargo box of a vehicle, which improves rigidity of a rear side portion where a tailgate is connected to the cargo box.

### Description of Related Art

In a vehicle such as a pickup truck, a cabin for accommodating occupants is formed at a front side of the vehicle, and a cargo box for loading or unloading a cargo is formed at a rear side of the vehicle.

In a frame body-type pickup truck, a cabin 12 and a cargo box 13 are disposed on an upper portion of a frame 11 which extends in a longitudinal direction of the vehicle 1 as shown in FIG. 1.

The cargo box 13 is provided with a plurality of structural members between an external panel 13a and an internal panel and connects these members to provide rigidity to the cargo box 13.

However, in the cargo box 13 of the vehicle 1 according to the related art, portions where the members are not connected to each other are present, and there is a problem in that the rigidity is degraded in these portions.

For example, a pair of D-posts on which a tailgate 14 with a heavy weight is hinged at a rear end portion of the cargo box 13, has a structure in which a plurality of plates is simply connected in certain arrangements and fastened to each other so that there is a problem in that the D-posts may not firmly support the tailgate.

### BRIEF SUMMARY

Various aspects of the present disclosure are directed to providing a rear side structure of a cargo box of a vehicle, which improves rigidity of a rear side portion where a tailgate is provided in the cargo box of the vehicle.

Other objects and advantages of the present disclosure may be understood by the following description and become apparent with reference to the exemplary embodiments of the present disclosure. Also, it is obvious to those skilled in the art to which the present disclosure pertains that the objects and advantages of the present disclosure may be realized by the means as claimed and combinations thereof.

In accordance with an exemplary embodiment of the present disclosure, there is provided a rear side structure of a cargo box of a vehicle including a cabin where occupants board, which includes a side external panel provided on an external side of the cargo box and forming an exterior of the cargo box provided at a rear side of the cabin, a side internal panel provided on an internal side of the side external panel in the cargo box, a D-post external member forming an external side of a pair of D-posts configured to support a tailgate at opposite sides of the cargo box, a D-post internal member forming an internal side of the pair of the D-posts and fastened to the D-post external member, and a rear floor member disposed at a rear end portion of the cargo box in a width direction of the vehicle and connected to a lower end portion of the pair of the D-posts.

The rear floor member may include a lower rear floor member fastened to a frame of the vehicle, and an upper rear floor member positioned above the lower rear floor member.

The rear side structure may further include a side upper member disposed at an upper end portion of the side external panel or an upper end portion of the side internal panel in a longitudinal direction of the vehicle, wherein an upper end portion of the D-post external member and an upper end portion of the D-post internal member may be fastened to the side upper member.

The D-post external member may be fastened to an end portion of the upper rear floor member.

A side end portion of the upper rear floor member and a side end portion of the lower rear floor member may be bent downward, and a lower end portion of the D-post external member may be fastened to the side end portion of the upper rear floor member.

The D-post internal member may be fastened to the upper rear floor member through a lower reinforce.

The lower reinforce may be formed to be bent, may be brought into contact with the lower end portion of the D-post internal member and an upper surface of the upper rear floor member, and may be fastened to a lower end portion of the D-post internal member and the upper surface of the upper rear floor member.

The rear side structure may further include an internal reinforce connecting a bottom surface of the upper rear floor member to the lower rear floor member between the upper rear floor member and the lower rear floor member.

The internal reinforce may be formed to include a step portion, the internal reinforce may be fastened along with the lower reinforce configured to fasten the upper rear floor member to the D-post internal member at a portion where the internal reinforce is fastened to the upper rear floor member, and a frame mount formed in the frame may be fastened to a portion where the internal reinforce is fastened to the lower rear floor member.

The rear side structure may further include a center reinforce mounted between the D-post external member and the D-post internal member.

The center reinforce may be brought into contact with an internal surface of the D-post external member within a predetermined distance from a first end portion of the center reinforce, and the center reinforce may be brought into contact with an internal surface of the D-post internal member within a predetermined distance from a second end portion of the center reinforce.

In accordance with another exemplary embodiment of the present disclosure, there is provided a rear side structure of a cargo box of a vehicle including a cabin where occupants board, which includes a side external panel provided on an external side of the cargo box to form an exterior of the cargo box provided at a rear side of the cabin, a side internal panel provided on an internal side of the side external panel in the cargo box, a side upper member disposed at an upper end portion of the side external panel or an upper end portion of the side internal panel in a longitudinal direction of the vehicle, a D-post external member forming an external side of a pair of D-posts configured to support a tailgate at opposite sides of the cargo box, and a D-post internal member forming an internal side of the pair of the D-posts and fastened to the D-post external member, wherein an upper end portion of the D-post external member and an upper end portion of the D-post internal member may be fastened to the side upper member.

The side upper member may be formed so that a lower portion thereof is open and an upper surface and both side surfaces are formed to include a cross section bent at a right angle, respectively, and an upper end portion of the D-post external member and an upper end portion of the D-post internal member may be fastened on an internal surface of the side upper member.

A rear floor member may include a lower rear floor member fastened to a frame of the vehicle, and an upper rear floor member positioned above the lower rear floor member.

A side end portion of the upper rear floor member and a side end portion of the lower rear floor member may be bent downward, and a lower end portion of the D-post external member may be fastened to the side end portion of the upper rear floor member.

The D-post internal member may be fastened to the upper rear floor member through a lower reinforce, and the lower reinforce may be formed to be bent, may be brought into contact with the lower end portion of the D-post internal member and an upper surface of the upper rear floor member, and may be fastened to a lower end portion of the D-post internal member and the upper surface of the upper rear floor member.

The rear side structure according to an exemplary embodiment of the present disclosure may further include an internal reinforce connecting a bottom surface of the upper rear floor member to the lower rear floor member between the upper rear floor member and the lower rear floor member.

The internal reinforce may be formed to include a step portion, the internal reinforce may be fastened along with the lower reinforce configured to fasten the upper rear floor member to the D-post internal member at a portion where the internal reinforce is fastened to the upper rear floor member, and a frame mount formed in the frame may be fastened to a portion where the internal reinforce is fastened to the lower rear floor member.

The rear side structure according to an exemplary embodiment of the present disclosure may further include a center reinforce between the D-post external member and the D-post internal, and the center reinforce may be brought into contact with an internal surface of the D-post external member within a predetermined distance from a first end portion of the center reinforce, and the center reinforce may be brought into contact with an internal surface of the D-post internal member within a predetermined distance from a second end portion of the center reinforce.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic side view exemplarily illustrating a typical frame-body type pickup truck in the related art.

FIG. 2 is a perspective view exemplarily illustrating a cargo box of a vehicle to which a rear side structure of a cargo box of a vehicle according to an exemplary embodiment of the present disclosure is applied.

FIG. 3 is a front view exemplarily illustrating an interior of the cargo box to which a rear side structure of a cargo box of a vehicle according to an exemplary embodiment of the present disclosure is applied.

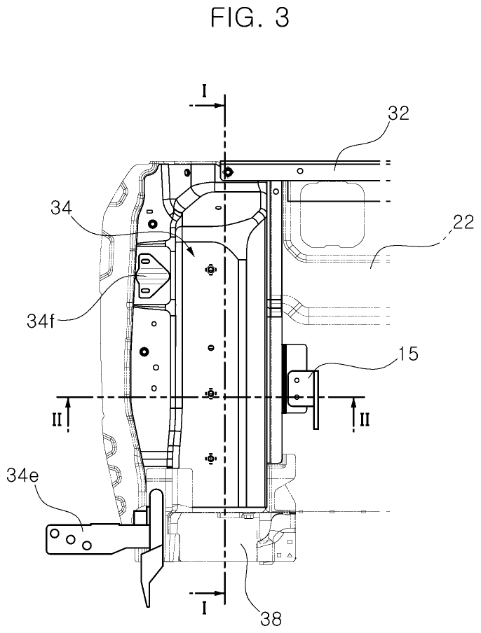

FIG. 4 is a perspective view exemplarily illustrating a rear side of the cargo box to which a rear side structure of a cargo box of a vehicle according to an exemplary embodiment of the present disclosure is applied.

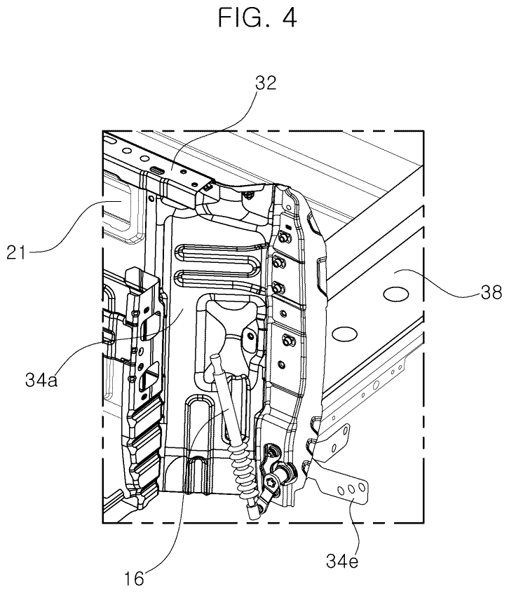

FIG. 5 is a cross-sectional view taken along line I-I of FIG. 3.

FIG. 6 is a cross-sectional view taken along line II-II of FIG. 3.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a rear side structure of a cargo box of a vehicle according to an exemplary embodiment of the present disclosure will be described in detail with reference to the accompanying drawings.

The rear side structure of a cargo box of a vehicle according to an exemplary embodiment of the present disclosure may include a side external panel 21 provided on an external side of a cargo box 13 to form an exterior of the cargo box 13 provided at a rear side of a cabin 12 where occupants board in a vehicle 1, a side internal panel 22 provided inside the side external panel 21 in the cargo box 13, a D-post external member 34a forming an external side of a pair of D-posts 34 configured to support a tailgate 14 at opposite sides of the cargo box 13, a D-post internal member 34b forming an internal side of the D-post 34 and fastened to the D-post external member 34a, and a rear floor member 38 disposed at a rear end portion of the cargo box 13 in a width direction of the vehicle 1 and connected to a lower end portion of the D-post 34.

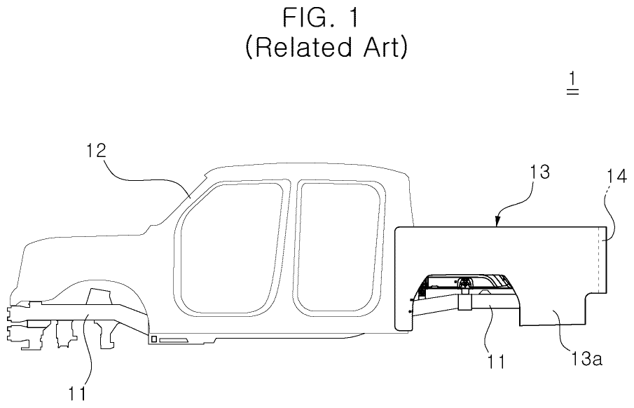

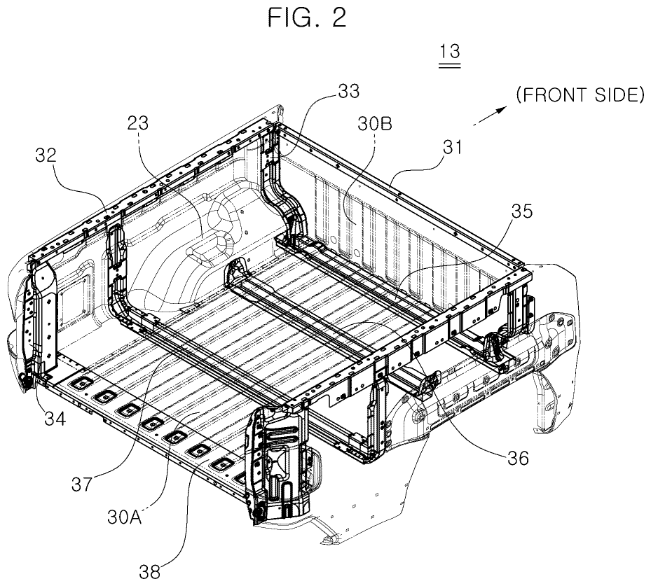

FIG. 2 shows a rear side structure of a cargo box 13 of a vehicle 1 according to an exemplary embodiment of the present disclosure. Referring to FIG. 1, in the vehicle 1 such as a pickup truck, the cabin 12 where occupants board is provided on an upper portion of a frame 11 which extends in a longitudinal direction of the vehicle 1, and the cargo box 13 for loading cargo is provided at a rear side of the cabin 12.

A rear side structure of a cargo box of a vehicle according to an exemplary embodiment of the present disclosure may be applied to the cargo box 13 of a small truck such as a pickup truck shown in FIG. 1.

A side portion of the cargo box 13 may be formed using the side external panel 21 and the side internal panel 22.

The side external panel 21 may be provided on an external side of the cargo box 13 to form an exterior of the cargo box 13.

The side internal panel 22 may be provided inside the side external panel 21.

The side external panel 21 and the side internal panel 22 may be disposed at intervals from each other, and respective upper end portions of the side external panel 21 and the side internal panel 22 are fastened to each other.

Here, referring to FIG. 2, a floor panel 30A on which the cargo is loaded and which forms a floor of the cargo box 13, a front panel 30B for closing a front end portion of the cargo box 13, and a tailgate 14 provided at a rear end portion of the cargo box 13 to be openable or closable, and thus a basic form of the cargo box 13 may be formed.

Furthermore, members which may reinforce the rigidity of the cargo box 13 may be additionally applied, and thus the rigidity of the cargo box 13 may be improved. A metal plate may be bent in a direction perpendicular to a longitudinal direction or a closed cross-section structure may be formed so that the rigidity of an individual member, which is applied to rigidity reinforcement, may be increased, and then the rigidity reinforced member may be applied to reinforce the rigidity of the cargo box 13.

Meanwhile, hereinafter, two members being fastened means that the two members are fastened to each other using welding (W) or bolts (B).

In an exemplary embodiment of the present disclosure, rigidity may be improved at the rear side portion of the cargo box 13 by D-posts 34 provided on the rear end portion of the cargo box 13 and the rear floor member 38 whose both end portions are fastened to lower end portions of the D-posts 34 provided on both sides of the rear end portion of the cargo box 13.

Because an upper end portion of the cargo box 13 should be supported, rigidity of the rear side portion of the cargo box 13 may be improved through the side upper member 32. The side upper member 32 may be disposed on an upper end portion of the side external panel 21 or an upper end portion of the side internal panel 22 in a longitudinal direction of the vehicle 1. Furthermore, the side upper member 32 may be formed so that the lower portion is open and the upper surface and both side surfaces are each formed to include a cross section bent at a right angle. By arranging the side upper member 32 between the side external panel 21 and the side internal panel 22 at the upper end portion of the cargo box 13, the side upper member 32 may support the rigidity of the rear side portion of the cargo box 13, specially a load input through an upper portion of the side portion of the cargo box 13.

The tailgate 14 may be provided at the rear end portion of the cargo box 13, the D-post 34 supporting the tailgate 14 may be provided, and thus the rigidity of the rear end portion of the cargo box 13 may be improved using the D-post 34.

The D-post 34 includes a D-post external member 34a forming an external side of the D-post 34 and a D-post internal member 34b forming an internal side of the D-post 34. The D-post external member 34a may be disposed to face an outside of the cargo box 13, and the D-post internal member 34b may be disposed to face an inside of the cargo box 13.

Upper end portions and lower end portions of the D-post external member 34a and the D-post internal member 34b may be fastened to form the D-post 34. The upper end portion of the D-post external member 34a and the upper end portion of the D-post internal member 34b may be directly fastened to each other. That is, the upper end portion of the D-post external member 34a and the upper end portion of the D-post internal member 34b may be fastened together to an internal side surface of the cargo box 13 at the side upper member 32.

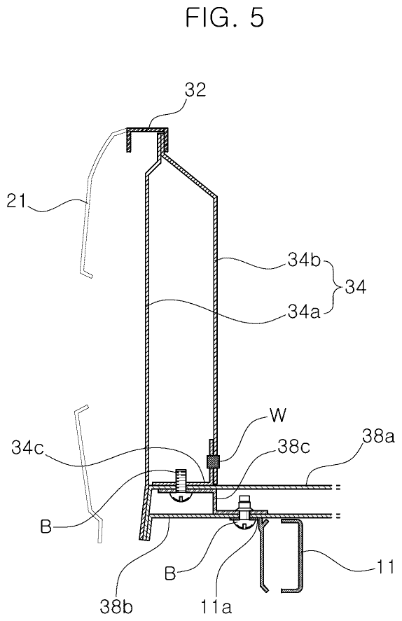

Meanwhile, the lower end portion of the D-post external member 34a and the lower end portion of the D-post internal member 34b may be disposed in the width direction of the vehicle 1 at the rear end portion of the cargo box 13 and may be fastened through the rear floor member 38 which connects the lower end portions of the D-posts 34 disposed on the sides of the rear end portion of the cargo box 13, as shown in FIG. 5.

The rear floor member 38 includes a lower rear floor member 38b fastened to the frame 11 of the vehicle 1 and an upper rear floor member 38a positioned above the lower rear floor member 38b.

The D-post external member 34a may be fastened to an end portion of the upper rear floor member 38a. That is, a side end portion of the upper rear floor member 38a and a side end portion of the lower rear floor member 38b may be bent downward, and the lower end portion of the D-post external member 34a may be fastened to the side end portion of the upper rear floor member 38a.

Meanwhile, the D-post internal member 34b may be fastened to the upper rear floor member 38a by the medium of a lower reinforce 34c. The lower reinforce 34c may be formed to be bent in a right-angle, may be brought into contact with the lower end portion of the D-post internal member 34b and an upper surface of the upper rear floor member 38a, and may be fastened to the lower end portion of the D-post internal member 34b and the upper surface of the upper rear floor member 38a.

In an exemplary embodiment of the present disclosure, the lower reinforce 34c may be fastened to the lower end portion of the D-post internal member 34b by welding W and the upper surface of the upper rear floor member 38a by a bolt B.

Furthermore, an internal reinforce 38c connects a bottom surface of the upper rear floor member 38a to the lower rear floor member 38b between the upper rear floor member 38a and the lower rear floor member 38b. The internal reinforce 38c may be bent and formed to include a step difference, and thus an upper surface of the internal reinforce 38c may be fastened to the bottom surface of the upper rear floor member 38a, and a lower surface thereof may be fastened to an upper surface of the lower rear floor member 38b.

In an exemplary embodiment of the present disclosure, the upper surface of the internal reinforce 38c may be fastened to the bottom surface of the upper rear floor member 38a, and the lower surface thereof may be fastened to the upper surface of the lower rear floor member 38b by bolts B.

The lower reinforce 34c and the internal reinforce 38c may be fastened to the upper surface and the lower surface of the upper rear floor member 38a, respectively. That is, the internal reinforce 38c may be fastened along with the lower reinforce 34c at a portion, wherein the internal reinforce 38c is fastened to the upper rear floor member 38a.

Furthermore, a frame mount 11a formed at the frame 11 may be fastened to a portion where the internal reinforce 38c is fastened to the lower rear floor member 38b. That is, the frame mount 11a may be formed at the frame 11 of the vehicle 1, and the frame mount 11a may be fastened to the lower rear floor member 38b so that the frame 11 and the rear floor member 38 are fastened to each other.

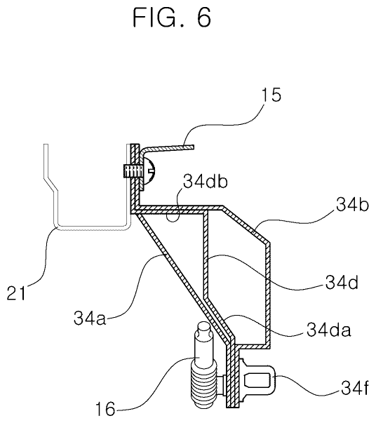

FIG. 6 shows a cross-sectional view exemplarily illustrating the D-post 34 cut in a direction perpendicular to the ground. Referring to FIG. 6, a center reinforce 34d may be provided between the D-post external member 34a and the D-post internal member 34b.

The center reinforce 34d may be brought into contact with the internal surface of the D-post external member 34a within a predetermined distance from one end portion of the center reinforce 34d, and the center reinforce 34d may be brought into contact with the internal surface of the D-post internal member 34b within a predetermined distance from the other end portion of the center reinforce 34d. That is, in FIG. 6, the center reinforce 34d may be configured to be brought into contact with the D-post external member 34a in a partial section 34da and brought into contact with the D-post internal member 34b in an opposite partial section 34db.

A hook 15 or a striker 34f may be provided on a surface where the center reinforce 34d may be fastened to the D-post external member 34a and the D-post internal member 34b.

In the present way, the upper end portion of the rear side portion of the cargo box 13 may be fastened to the side upper member 32 by the D-post 34 perpendicular to the ground, and the lower end portion thereof may be connected to the rear floor member 38 so that the rear end portion of the side upper member 32 is securely supported. Thus, rigidity of the rear side portion of the cargo box 13 may be improved.

The striker 34f, which is locked to or released from a latch when the tailgate 14 is closed, may be installed at one side of the D-post 34. Furthermore, a gas lift 16 may be installed on one side of the D-post 34 to facilitate opening and closing of the tailgate 14.

Meanwhile, the cargo box 13 may be provided with floor members 35, 36, and 37 disposed in the width direction of the vehicle 1 from a front end portion of the cargo box 13 or extending upward in a state of being disposed in the width direction of the vehicle 1. For example, the first floor member 35, the second floor member 36, and the third floor member 37 may be disposed from the front end portion of the cargo box 13 to the rear side of the vehicle 1.

The first floor member 35 may be fastened to the lower end portion of the front side member 33, which is provided at a front end portion of the side portion of the cargo box 13 and whose upper end portion is fastened to the side upper member 32, a front end portion of the side upper member 32.

Both end portions of the second floor member 36 may be fastened to a wheel house 23.

The third floor member 37 may be formed to extend in the width direction of the vehicle 1 and then extend upward between the second floor member 36 and the rear floor member 38. An end portion of the third floor member 37 may be fastened to the side upper member 32, so that the third floor member 37 supports the side upper member 32 in the middle portion of the cargo box 13.

Furthermore, a front guard 31 whose both end portions are fastened to the side upper member 32 is provided at an upper end portion of the front end portion of the cargo box 13.

34e having no reference numeral is a hinge through which the tailgate 14 is connected to the cargo box 13.

In accordance with a rear side structure of a cargo box of a vehicle of the present disclosure, which includes the above-described configuration, rigidity of a D-post supporting a tailgate may be improved so that even when the tailgate with a heavy weight is repeatedly operated, a rear side portion of the cargo box may be prevented from being deformed.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A rear side structure of a cargo box of a vehicle including a cabin where occupants board, the rear side structure comprising:
a side external panel provided on an external side of the cargo box and forming an exterior of the cargo box provided at a rear side of the cabin;
a side internal panel provided on an internal side of the side external panel in the cargo box;
a D-post external member forming an external side of a pair of D-posts configured to support a tailgate at opposite sides of the cargo box;
a D-post internal member forming an internal side of the pair of the D-posts and fastened to the D-post external member; and
a rear floor member disposed at a rear end portion of the cargo box in a width direction of the vehicle and connected to a lower end portion of the pair of the D-posts.

2. The rear side structure of claim 1, wherein the rear floor member includes:
a lower rear floor member fastened to a frame of the vehicle; and
an upper rear floor member positioned above the lower rear floor member.

3. The rear side structure of claim 2, further including:
a side upper member disposed at an upper end portion of the side external panel or an upper end portion of the side internal panel in a longitudinal direction of the vehicle,
wherein an upper end portion of the D-post external member and an upper end portion of the D-post internal member are fastened to the side upper member.

4. The rear side structure of claim 3, wherein the D-post external member is fastened to an end portion of the upper rear floor member.

5. The rear side structure of claim 4,
wherein a side end portion of the upper rear floor member and a side end portion of the lower rear floor member are bent downward, and
wherein a lower end portion of the D-post external member is fastened to the side end portion of the upper rear floor member.

6. The rear side structure of claim 3, wherein the D-post internal member is fastened to the upper rear floor member through a lower reinforce.

7. The rear side structure of claim 6, wherein the lower reinforce is formed to be bent, is brought into contact with a lower end portion of the D-post internal member and an upper surface of the upper rear floor member, and is fastened to the lower end portion of the D-post internal member and the upper surface of the upper rear floor member.

8. The rear side structure of claim 3, further including:
an internal reinforce connecting a bottom surface of the upper rear floor member to the lower rear floor member between the upper rear floor member and the lower rear floor member.

9. The rear side structure of claim 8,
wherein the internal reinforce includes a step portion,
wherein the internal reinforce is fastened along with the lower reinforce configured to fasten the upper rear floor member to the D-post internal member at a portion where the internal reinforce is fastened to the upper rear floor member, and
wherein a frame mount formed in the frame is fastened to a portion where the internal reinforce is fastened to the lower rear floor member.

10. The rear side structure of claim 1, further including a center reinforce mounted between the D-post external member and the D-post internal member.

11. The rear side structure of claim 10, wherein the center reinforce is brought into contact with an internal surface of the D-post external member within a predetermined distance from a first end portion of the center reinforce, and the center reinforce is brought into contact with an internal surface of the D-post internal member within a predetermined distance from a second end portion of the center reinforce.

12. A rear side structure of a cargo box of a vehicle including a cabin where occupants board, the rear side structure including:
a side external panel provided on an external side of the cargo box to form an exterior of the cargo box provided at a rear side of the cabin;
a side internal panel provided on an internal side of the side external panel in the cargo box;
a side upper member disposed at an upper end portion of the side external panel or an upper end portion of the side internal panel in a longitudinal direction of the vehicle;
a D-post external member which forms an external side of a pair of D-posts configured to support a tailgate at opposite sides of the cargo box; and
a D-post internal member forming an internal side of the pair of the D-posts and is fastened to the D-post external member,
wherein an upper end portion of the D-post external member and an upper end portion of the D-post internal member are fastened to the side upper member.

13. The rear side structure of claim 12,
wherein the side upper member is formed so that a lower portion of the side upper member is open and an upper surface and first and second side surfaces of the side upper member are each formed to include a cross section bent at a right angle, respectively, and
wherein the upper end portion of the D-post external member and the upper end portion of the D-post internal member are fastened on an internal surface of the side upper member.

14. The rear side structure of claim 12, further including a rear floor member which is disposed at a rear end portion of the cargo box in a width direction of the vehicle and which connects a lower end portion of the pair of the D-posts.

15. The rear side structure of claim 14, wherein the rear floor member includes:
a lower rear floor member fastened to a frame of the vehicle; and
an upper rear floor member positioned above the lower rear floor member.

16. The rear side structure of claim 15,
wherein a side end portion of the upper rear floor member and a side end portion of the lower rear floor member are bent downward, and
wherein a lower end portion of the D-post external member is fastened to the side end portion of the upper rear floor member.

17. The rear side structure of claim 15,
wherein the D-post internal member is fastened to the upper rear floor member through a lower reinforce, and
wherein the lower reinforce is formed to be bent, is brought into contact with a lower end portion of the D-post internal member and an upper surface of the upper rear floor member, and is fastened to the lower end portion of the D-post internal member and the upper surface of the upper rear floor member.

18. The rear side structure of claim 15, further including an internal reinforce connecting a bottom surface of the upper rear floor member to the lower rear floor member between the upper rear floor member and the lower rear floor member.

19. The rear side structure of claim 18,
wherein the internal reinforce includes a step portion,
wherein the internal reinforce is fastened along with the lower reinforce configured to fasten the upper rear floor member to the D-post internal member at a portion where the internal reinforce is fastened to the upper rear floor member, and
wherein a frame mount formed in the frame is fastened to a portion where the internal reinforce is fastened to the lower rear floor member.

20. The rear side structure of claim 12, further including:
a center reinforce between the D-post external member and the D-post internal,
wherein the center reinforce is brought into contact with an internal surface of the D-post external member within a predetermined distance from a first end portion of the center reinforce, and the center reinforce is brought into contact with an internal surface of the D-post internal member within a predetermined distance from a second end portion of the center reinforce.
